(19) United States
(12) Patent Application Publication
(10) Pub. No.: US 2014/0379454 A1
(43) Pub. Date: Dec. 25, 2014

(54) Systems and Methods for Controlling a Coupon Redemption Characteristic

(71) Applicant: Verify Holdings, LLC, Minneapolis, MN (US)

(72) Inventor: Jason GEYEN, Maple Grove, MN (US)

(73) Assignee: Verify Holdings, LLC, Minneapolis, MN (US)

(21) Appl. No.: 14/265,979

(22) Filed: Apr. 30, 2014

Related U.S. Application Data
(60) Provisional application No. 61/836,918, filed on Jun. 19, 2013.

(51) Int. Cl. G06Q 30/02

(52) U.S. Cl. CPC G06Q 30/0235; G06Q 30/0233
USPC 705/14.33; 705/14.35

(57) ABSTRACT

Systems and methods for controlling redemption of an electronic coupon involve issuing an electronic coupon with a predetermined redemption characteristic and later updating the redemption characteristic of the electronic coupon based on one or more factors.

### BACKGROUND OF THE INVENTION

Exemplary embodiments of the present invention are directed to systems and methods for controlling the redemption of electronic coupons. Paper coupons have been used for a very long time as a way to incentivize purchases. A consumer typically obtains printed coupons from newspapers, magazines, or in the mail. These printed coupons include a stated redemption value and expiration date so that both the consumer and a redeeming merchant are aware of the value and expiration of the coupon. For example, the coupon may indicate a dollar or percentage discount off of a purchase price. It is also known to issue personalized coupons based on a consumer's purchasing habits. For example, it is common for grocery stores to issue coupons at the check-out register based on current or past purchases. One problem with printed coupons is that the redemption value and expiration do not change once the coupon is issued in printed form.

With the increasing usage of mobile telephones, electronic coupons are now becoming more common. As with conventional paper coupons, these electronic coupons typically have stated redemption values and expirations that do not change once the coupon is issued. Similarly, location-based advertisements are known in which an advertisement along with a coupon can be provided to the user of a mobile telephone depending upon geographic location. Again, once the coupon is issued to the consumer's mobile telephone, the redemption value and expiration do not change.

### SUMMARY OF THE INVENTION

Although conventional paper and electronic coupons have provided a mechanism to incentivize purchases, fixing the redemption value and expiration after the issuance of the coupon limits a coupon issuer's control over the redemption. For example, a coupon issuer typically sets the redemption value and expiration based on an assumed redemption rate and budget for the associated promotion. If there are more redemptions than the assumed redemption rate, the coupon issuer will exceed its budget for the coupon promotion.

Accordingly, exemplary embodiments of the present invention provide systems and methods for controlling redemption of electronic coupons.

An exemplary method of controlling redemption of an electronic coupon, involves a coupon server issuing an electronic coupon to an end-user device, wherein the electronic coupon is issued with a predetermined redemption characteristic, determining, based on a variable factor, an updated redemption characteristic of the issued electronic coupon, and informing the end-user device of the updated redemption characteristic. The variable factor includes at least one of a geographic location, a date, a time of day, a day of a week, a number of redemptions by a particular person, valued activities performed by a particular person.

An exemplary system includes an end-user device and a coupon server. The coupon server is configured to issue an electronic coupon to the end-user device with a predetermined redemption characteristic, determine, based on a variable factor, an updated redemption characteristic of the electronic coupon, and inform the end-user device of the updated redemption characteristic. The variable factor includes at least one of a geographic location, a date, a time of day, a day of a week, a number of redemptions by a particular person, valued activities performed by a particular person.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a block diagram of an exemplary system in accordance with the present invention;

FIG. 2 is a flow diagram of an exemplary method of controlling a redemption characteristic of an electronic coupon in accordance with the present invention; and

FIGS. 3A-3C, 4, and 5 are block diagrams of exemplary coupons in accordance with the present invention.

### DETAILED DESCRIPTION OF THE PREFERRED EMBODIMENTS

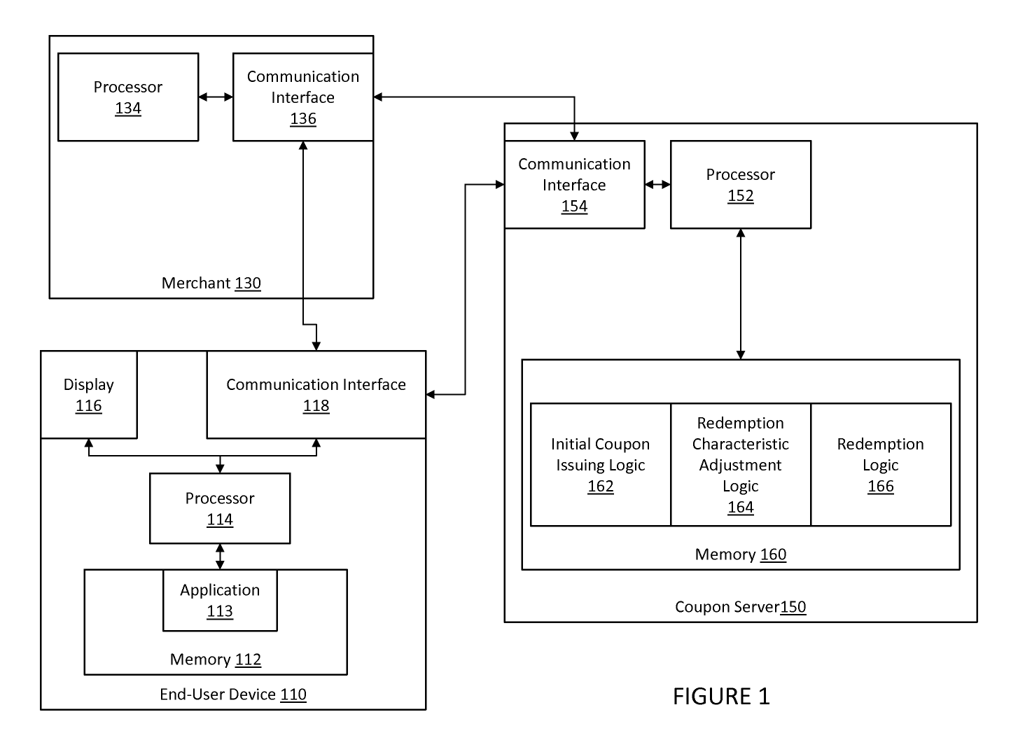

FIG. 1 is a block diagram of an exemplary system in accordance with the present invention. The exemplary system includes an end-user device 110 that can obtain an electronic coupon from coupon server 150, and redeem the electronic coupon with merchant 130, which is then credited for the redemption amount by coupon server 150. For ease of explanation, and not limitation, the coupon server 150 can be considered as the coupon issuer.

The end-user device 110 can be any type of device, including a cellular telephone, smart phone, personal digital assistant (PDA), computer, tablet, slate, and/or the like. The end-user device includes a memory 112 that can store one or more applications 113, which applications are executed by processor 114. The electronic coupon can be stored and used as part of a dedicated coupon application or can be stored as part of another application (e.g., it can be stored in an e-mail, text message, text document, presentation document, portable document file (PDF) document, etc.) Processor 114 is connected to communication interface 118, which can be one or more communication interfaces that support wired and/or wireless communications. For example, communication interface 118 can support wide area network cellular wireless communications (e.g., CDMA, LTE, GSM, WiMAX, etc.) and short-range wireless communication (e.g., Bluetooth, near-field communications (NFC), RF-ID, infrared (IR), WiFi, etc.). The end-user device also includes a display 116, which can display, among other things, an electronic coupon to an operator of the end-user device.

Merchant 130 includes a processor 134 operatively coupled to a communication interface 136, which can be one or more communication interfaces that support the same or different types of wired and/or wireless communications as communication interface 118 of end-user device 110.

Coupon server 150 includes non-transitory memory 160, which stores one or more programs embodied as logic 162-166. This logic is executed by processor 152 to perform certain functions, which will be described in more detail below. Communication interface 154 can be one or more communication interfaces that support the same or different types of wired and/or wireless communications as communication interface 118 of end-user device 110 and communication interface 136 of merchant 130.

The various processors described above can be microprocessors, field programmable gate arrays (FPGA), and/or application specific integrated processors (ASIC). These various processors are specifically programmed to carry out the functions disclosed and claimed in the present application.

Although FIG. 1 illustrates a single end-user device 110 interacting with a single merchant 130 and a single coupon server 150, the present invention is not so limited. For example, end-user device 110 can interact with more than one merchant 130 and merchant 130 can interact with more than one end-user device 110. Similarly, end-user device 110 can interact with more than one coupon server 150 and coupon server 150 can interact with more than one end-user device. Moreover, merchant 130 can interface with more than one coupon server 150 and coupon server 150 can interact with more than one merchant 130.

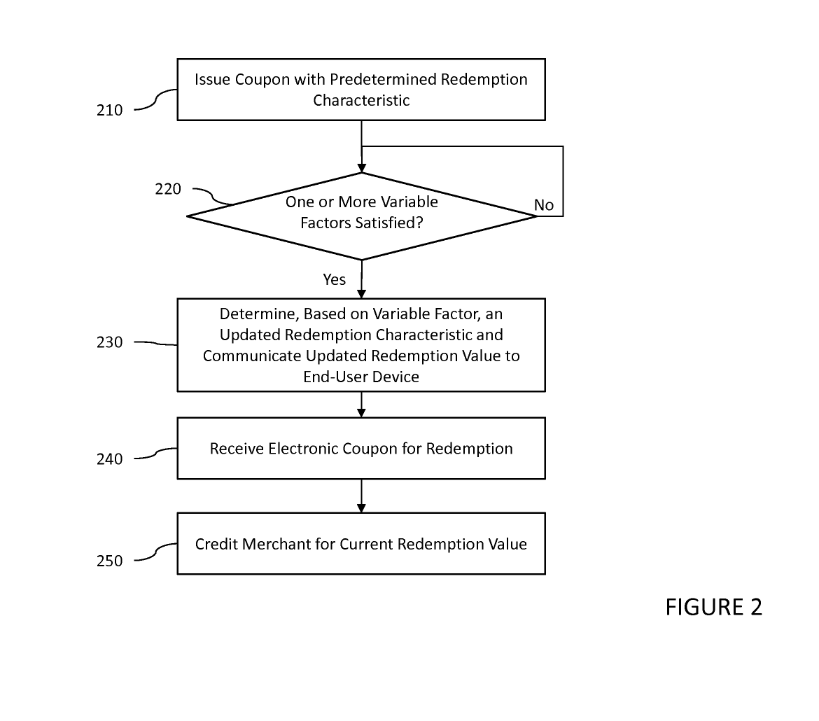

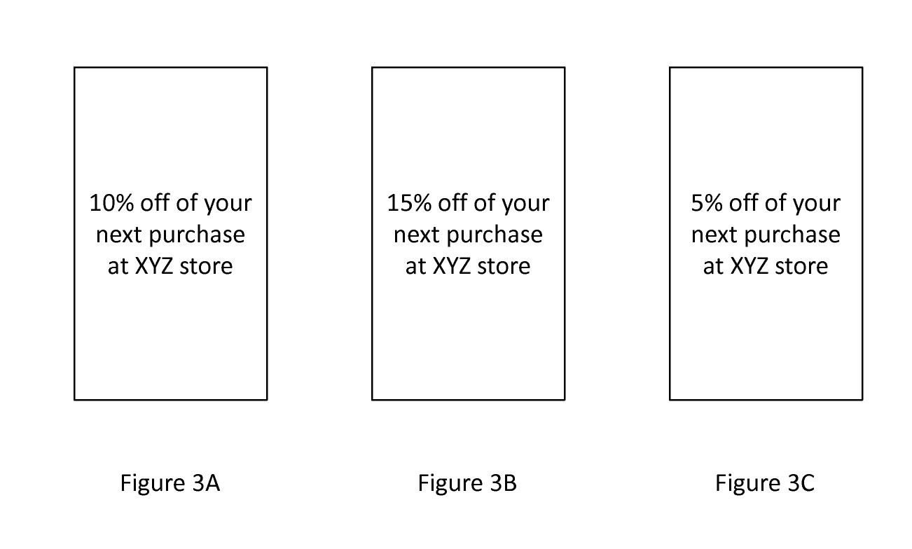

FIG. 2 is a flow diagram of an exemplary method of controlling a redemption characteristic of an electronic coupon in accordance with the present invention. Initially, coupon server 150 uses logic 162 to issue an electronic coupon to end-user device 110 via communication interfaces 154 and 118 (step 210). When issued, the electronic coupon has a predetermined redemption characteristic. The redemption characteristic can be any type of characteristic of the electronic coupon, such as a redemption value, expiration date, and/or redemption quantity (e.g., a number of times the coupon can be redeemed or a minimum or maximum number of products required for purchase to receive the redemption value). End-user device 110 can display the coupon on display 116, an example of which is illustrated in FIG. 3A. After the electronic coupon is issued with the predetermined redemption characteristic, logic 164 of coupon server 150 determines whether one or more variable factors are satisfied (step 220), and if so an updated redemption characteristic is determined using one or more of the variable factors and the updated redemption characteristic is communicated to end-user device 110 (step 230). The updated redemption characteristic is illustrated in FIG. 3B as an increase in the redemption value and in FIG. 3C as a decrease in the redemption value.

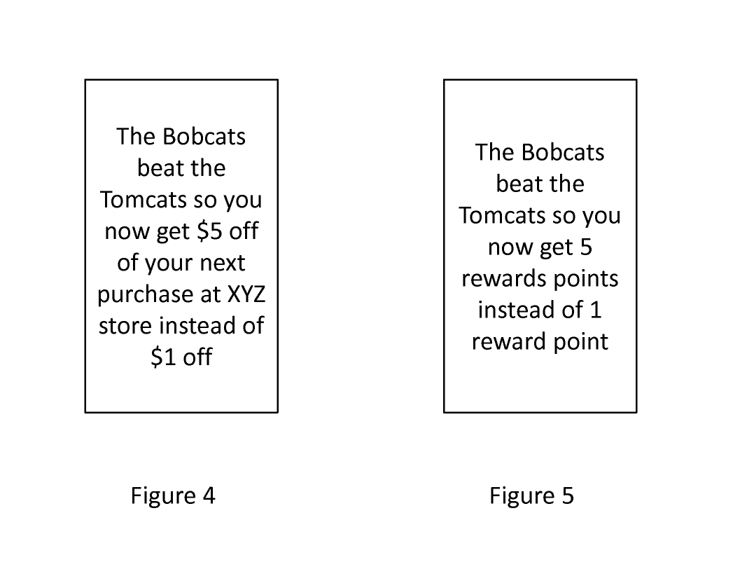

The variable factor can be any factor desired by the coupon issuer to control, incentivize, and/or deincentivize the redemption of the coupon and purchase or certain products based on the occurrence of particular events. The particular events can include one or more of a geographic location, a date, a time of day, a day of a week, a number of redemptions by a particular person, valued activities performed by a particular person, if a particular sporting team wins a particular game, a particular sporting team achieves a certain score, a number of certain types of scores (e.g., a number of field goals in a football game), a number of statistical-based events for a player or team (e.g., a number of home runs in a baseball game or a number of sacks in a football game), the occurrence of a full moon, and/or the like. An example of this is illustrated in FIG. 4, which illustrates an increased discount because one sports team beat another.

Further, the variable factor can be adjusted, as desired, to control the how many redemptions are made from a particular geographic location or area. For example, conventional coupons could be redeemed so that there are a large number of redemptions within the same geographic area, whereas the coupon issuer may desire redemptions from a broader geographic area or redemptions that are more evenly distributed across geographic areas. Accordingly, the coupon issuer can determine that only a certain number of redemptions should come from any particular geographic area, which can be arbitrarily assigned as desired by the coupon issuer to be a city, county, state, country, etc. Alternatively or additionally, the coupon issuer can control redemptions by reducing the redemption value or shortening the redemption period (i.e., changing the redemption expiration date) in geographic areas having high redemption rates and increase redemption values or length the redemption period in geographic areas having low redemption rates. Thus, the coupon issuer can achieve a relatively smooth redemption curve across a number of geographic areas.

Similarly, the variable factor can be adjusted so that the redemptions occur over a period of time of the redemption period, which can avoid having more redemptions than the assumed redemption rate and/or exceeding the budget for the coupon promotion. For example, if the redemption rate on a monthly, weekly, daily, or hourly basis exceeds the redemption rate model, the redemption value can be reduced and/or the redemption expiration can be shortened for a period of time. If the redemption rate then begins to fall below the assumed redemption rate, the redemption value can be increased to the predetermined redemption value or above that value and/or the expiration can be reset to the original expiration or lengthened beyond that. Thus, the variable factor can then be used to space out the amount of the budget for the coupon promotion over the remainder of the promotion period. It will be recognized that the redemption rate accounts for the total number of redemptions for a period of time, such as the total number of redemptions for the entire promotion, for a particular day, week, or month.

Moreover, the coupon issuer may desire to reward persons that have performed certain valued activities more than persons that have not. Such valued activities could include “Friending” or “Following” the coupon issuer on a social media website or application, being a member of the coupon issuer's rewards program, purchasing a certain amount of the coupon issuer's products, etc.

The variable factor can be employed in any manner to achieve the coupon issuer's desired goals. Thus, for example, if a coupon has been redeemed from a particular person or end-user device, the variable factor can be used so that the particular person or end-user device is excluded from redeeming the coupon again, the redemption value can be reduced/increased for future redemptions by the particular person or end-user device, and/or the expiration can be lengthened or shortened for a particular person or end-user device. On the other hand, the variable factor can be used to increase the likelihood of redemption by increasing the redemption value or lengthening the expiration for being in a geographic area that has a lower than expected redemption rate.

Returning to FIG. 2, when merchant 130 receives an electronic coupon for redemption from end-user device 110, the merchant's processor 134 uses communication interface 136 to notify coupon server 150 of the redemption (step 240). The electronic coupon can be received for redemption by merchant 130 from end-user device 110 in a number of ways, including the merchant 130 scanning a code (e.g., a barcode or quick response (QR) code) on display 116 of end-user device 116 or the end-user device 110 transferring the electronic coupon via communication interfaces 118 and 136 (e.g., using a wired or wireless connection, such as Bluetooth, WiFi, infrared (IR), radio frequency identification (RF-ID), near-field communication (NFC), etc.). Coupon server 150 uses logic 166 to process the redemption and credit the merchant 130 for the current redemption value (step 250).

As should be appreciated from the discussion above, one advantage of the coupons of the present invention compared to conventional coupons is that the coupons of the present invention are highly customizable and can be personalized so as to either encourage certain types of redemptions, e.g., redemptions on a particular day or from a particular geographic area. Thus, the coupons of the present invention could be used as part of a loyalty rewards program as either single-use or multiple-use coupons. In this case the code for the electronic coupon would not necessarily be redeemed at a merchant but could also be redeemed for credits or points in connection with the loyalty rewards program. Because the present invention provides for a variable redemption characteristic, the value of the credits or points could vary depending upon any type of variable factor. An example of this is illustrated in FIG. 5 in which the rewards points increased because one sports team beat another.

Although the discussion above references coupons for products, it should be understood that this also relates to coupons for services or a combination of products and services. Furthermore, the discussion above equates the coupon server with the coupon issuer. It should be recognized that the selection of and changes to the variable factor can be made by the brand owner of the product/service that is the subject of the coupon, the retailer of the product/service, and/or a third party operating the promotional campaign on behalf of the brand owner and/or retailer. In this regard it should be noted that in some instances promotional campaigns are conducted jointly by brand owners and retailers.

Although exemplary embodiments have been described in connection with electronic coupons that are redeemed using an end-user device, the present invention is equally applicable to printed coupons. Specifically, the redemption characteristic adjustment logic resides in the coupon server, and thus an end-user device is not necessarily required. In the case of printed coupons, instead of informing an end-user device of the update redemption characteristic, the end-user himself/herself would be informed. This can be performed when the end-user is redeeming the coupon and/or the end-user can be informed by electronic means, such as by accessing a website, by e-mail, text message, and/or the like.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of controlling redemption of a coupon, the method comprising:
issuing, by a coupon server, a coupon to an end-user, wherein the coupon is issued with a predetermined redemption characteristic;
determining, by the coupon server based on a variable factor, an updated redemption characteristic of the issued coupon; and
informing, by the coupon server, the end-user of the updated redemption characteristic,
wherein the variable factor includes at least one of a geographic location, a date, a time of day, a day of a week, a number of redemptions by a particular person or device, total number of redemptions, redemptions set by parameters determined by the brand owner or retailer, or valued activities performed by a particular person.

2. The method of claim 1, wherein the redemption characteristic is at least one of a redemption value, a redemption expiration date, and a redemption quantity.

3. The method of claim 2, wherein the redemption characteristic is a redemption value, the method further comprising:
crediting, by the coupon server, a merchant for an updated redemption value when the coupon is redeemed with the merchant.

4. The method of claim 1, wherein the coupon is an electronic coupon that is issued to an end-user device and the end-user is informed of the updated redemption characteristic via the end-user device.

5. The method of claim 2, wherein the redemption characteristic is an updated redemption expiration date, the method further comprising:
receiving, by the coupon server, a request for redemption of the coupon from a merchant;
determining, by the coupon server, whether a current date is before the updated expiration date;
wherein when
the current date is on or before the updated expiration date the coupon server credits the merchant for redeeming the coupon, and
the current date is after the updated expiration date the coupon server informs the merchant that the coupon has expired and is not redeemable.

6. The method of claim 1, wherein the parameters determined by the brand owner or retailer includes at least one of whether
a particular sporting team wins a particular game,
a particular sporting team achieves a certain score,
a particular sporting team achieves a number of certain types of scores, and
occurrence of a number of statistical-based events for a particular player or a particular sporting team.

7. The method of claim 1, wherein the coupon is associated with a loyalty program, the predetermined and updated redemption characteristic is an amount of credit or points, and redemption of the coupon adds the amount of credit or points to a loyalty program account of the end-user.

8. A system for controlling redemption of an electronic coupon, the system comprising:
an end-user device;
a coupon server configured to
issue an electronic coupon to the end-user device with a predetermined redemption characteristic;
determine, based on a variable factor, an updated redemption characteristic of the electronic coupon; and
inform the end-user device of the updated redemption characteristic;
wherein the variable factor includes at least one of a geographic location, a date, a time of day, a day of a week, a number of redemptions by a particular person or device, total number of redemptions, redemptions set by parameters determined by the brand owner or retailer, or valued activities performed by a particular person.

9. The system of claim 8, wherein the redemption characteristic is at least one of a redemption value, a redemption expiration date, and a redemption quantity.

10. The system of claim 9, wherein the redemption characteristic is a redemption value, the coupon server is further configured to:
credit a merchant for an updated redemption value when the electronic coupon is redeemed with the merchant.

11. The system of claim 8, wherein the coupon server is further configured to:
inform an operator of the end-user device of the predetermined redemption characteristic; and
inform the operator of the end-user device of the updated redemption characteristic after informing the operator of the predetermined redemption characteristic.

12. The system of claim 9, wherein the redemption characteristic is an updated redemption expiration date, the coupon server is further configured to:
receive a request for redemption of the electronic coupon from a merchant;
determine whether a current date is before the updated expiration date;
wherein when
the current date is on or before the updated expiration date the coupon server credits the merchant for redeeming the electronic coupon, and
the current date is after the updated expiration date the coupon server informs the merchant that the electronic coupon has expired and is not redeemable.

13. The system of claim 8, wherein the parameters determined by the brand owner or retailer includes at least one of whether
a particular sporting team wins a particular game,
a particular sporting team achieves a certain score,
a particular sporting team achieves a number of certain types of scores, and
occurrence of a number of statistical-based events for a particular player or a particular sporting team.

14. The system of claim 8, wherein the electronic coupon is associated with a loyalty program, the predetermined and updated redemption characteristic is an amount of credit or points, and redemption of the coupon adds the amount of credit or points to an loyalty program account of a user associated with the end-user device.

15. A coupon server, comprising:
a non-transitory memory; and
a processor coupled to the non-transitory memory, wherein the processor is configured to execute logic stored in the non-transitory memory, which causes the processor to
issue a coupon to an end-user, wherein the coupon is issued with a predetermined redemption characteristic;
determine, based on a variable factor, an updated redemption characteristic of the issued coupon; and
informing the end-user of the updated redemption characteristic,
wherein the variable factor includes at least one of a geographic location, a date, a time of day, a day of a week, a number of redemptions by a particular person or device, total number of redemptions, redemptions set by parameters determined by the brand owner or retailer, or valued activities performed by a particular person.

16. The coupon server of claim 15, wherein the redemption characteristic is at least one of a redemption value, a redemption expiration date, and a redemption quantity.

17. The coupon server of claim 15, wherein the coupon is an electronic coupon that is issued to an end-user device and the end-user is informed of the updated redemption characteristic via the end-user device.

18. The coupon server of claim 15, wherein the parameters determined by the brand owner or retailer includes at least one of whether
a particular sporting team wins a particular game,
a particular sporting team achieves a certain score,
a particular sporting team achieves a number of certain types of scores, and
occurrence of a number of statistical-based events for a particular player or a particular sporting team.

19. The coupon server of claim 15, wherein the coupon is associated with a loyalty program, the predetermined and updated redemption characteristic is an amount of credit or points, and redemption of the coupon adds the amount of credit or points to a loyalty program account of the end-user.
